(19) United States
(12) Patent Application Publication
(10) Pub. No.: US 2022/0347809 A1
(43) Pub. Date: Nov. 3, 2022

(54) Fence Post Jig Assembly

(71) Applicant: Eric Caloura, London (CA)

(72) Inventor: Eric Caloura, London (CA)

(21) Appl. No.: 17/242,378

(22) Filed: Apr. 28, 2021

(51) Int. Cl. B23Q 3/18

(52) U.S. Cl. CPC B23Q 3/18; E04H 17/20

(57) ABSTRACT

A fence post jig assembly includes a frame that has a plurality of intersecting sides such that the frame defines a rectangle. In this way the frame can be positioned around a fence post. The frame has a lip extending outwardly therefrom and the lip extends around each of the intersecting sides. Thus, the lip defines a guide surface that is oriented on a horizontal plane when the frame is positioned around the fence post. Moreover, the guide surface can guide a saw to cut the fence post along the horizontal plane thereby enhancing precision of cutting the fence post. A plurality of screws each extends through a respective one of the intersecting sides of the frame and each of the screws extends toward a center of the frame when the screws are tightened. In this way each of screws can engage the fence post for retaining the frame on the fence post at a desired height on the fence post.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to jig devices and more particularly pertains to a new jig device for precisely cutting a fence post to a desired height. The device includes a rectangular frame and a lip extending around the frame. The lip defines a horizontal guide surface for cutting the fence post when the frame is positioned around the fence post. Additionally, the device includes a plurality of screws, each extending through the frame, for engaging the fence post to retain the frame at a desired height on the fence post.

### (2) Description of Related Art Including Information Disclosed Under 37 CFR 1.97 and 1.98

The prior art relates to jig devices including a variety of spacing jigs for aligning a pair of fence posts with each other during the construction of a fence. Additionally, the prior art discloses a spacing guide for aligning pickets during construction of a fence. In no instance does the prior art disclose a rectangular frame that is positionable around a rectilinear fence post, and which includes a horizontal guide surface to guide a saw for precisely cutting a fence post to a desired height.

### BRIEF SUMMARY OF THE INVENTION

An embodiment of the disclosure meets the needs presented above by generally comprising a frame that has a plurality of intersecting sides such that the frame defines a rectangle. In this way the frame can be positioned around a fence post. The frame has a lip extending outwardly therefrom and the lip extends around each of the intersecting sides. Thus, the lip defines a guide surface that is oriented on a horizontal plane when the frame is positioned around the fence post. Moreover, the guide surface can guide a saw to cut the fence post along the horizontal plane thereby enhancing precision of cutting the fence post. A plurality of screws each extends through a respective one of the intersecting sides of the frame and each of the screws extends toward a center of the frame when the screws are tightened. In this way each of screws can engage the fence post for retaining the frame on the fence post at a desired height on the fence post.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a fence post jig assembly according to an embodiment of the disclosure.

FIG. 2 is a bottom perspective view of an embodiment of the disclosure.

FIG. 3 is a front phantom view of an embodiment of the disclosure.

FIG. 4 is a bottom view of an embodiment of the disclosure.

FIG. 5 is a perspective in-use view of an embodiment of the disclosure.

### DETAILED DESCRIPTION OF THE INVENTION

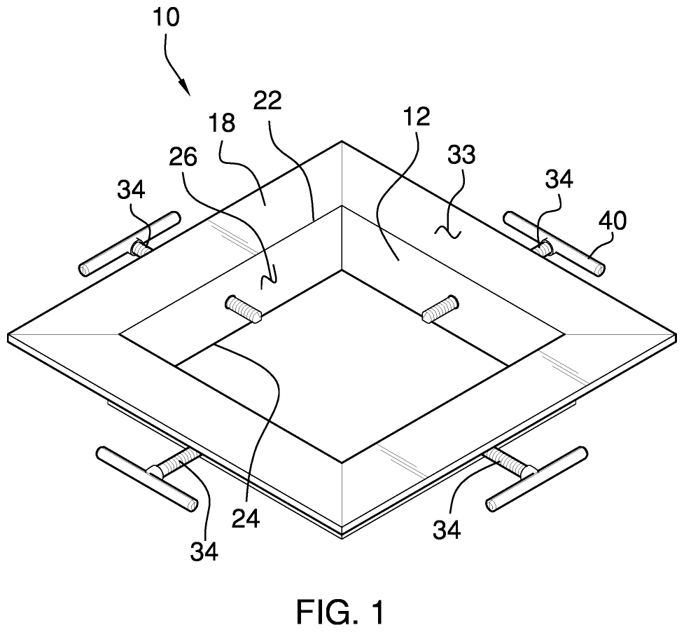

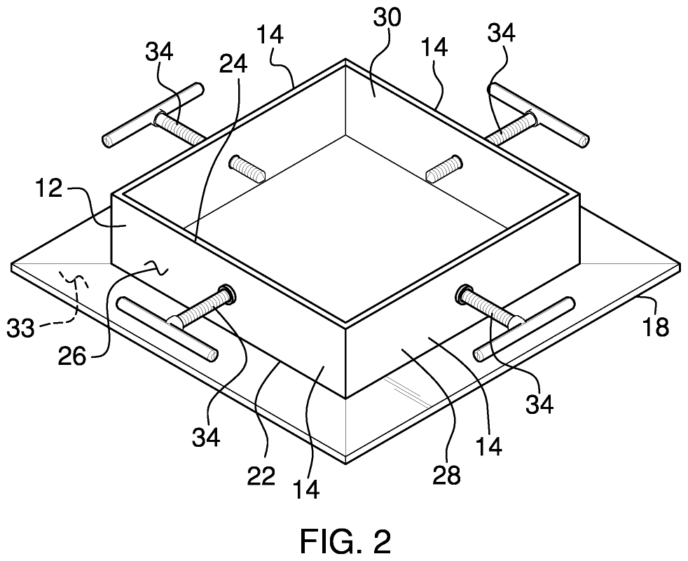

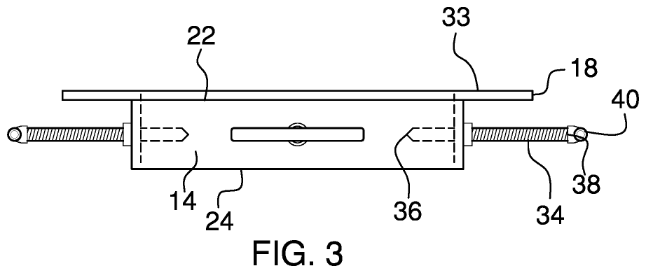

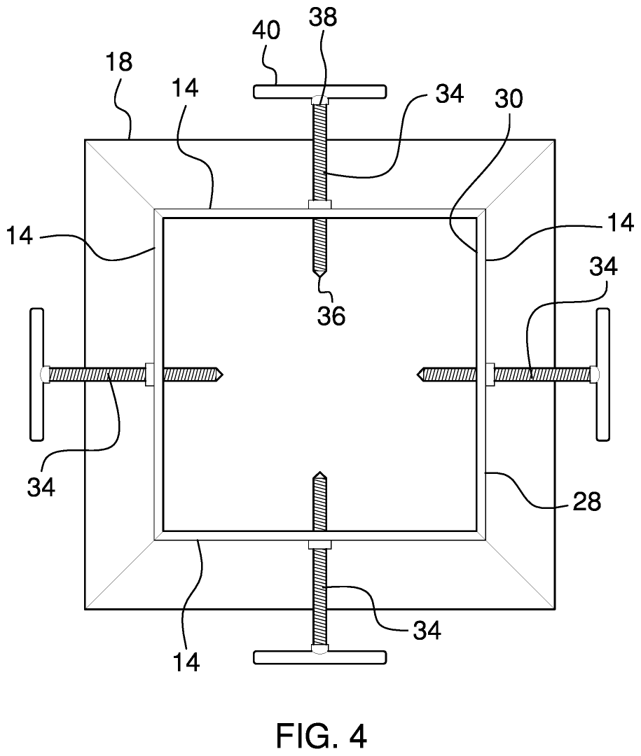

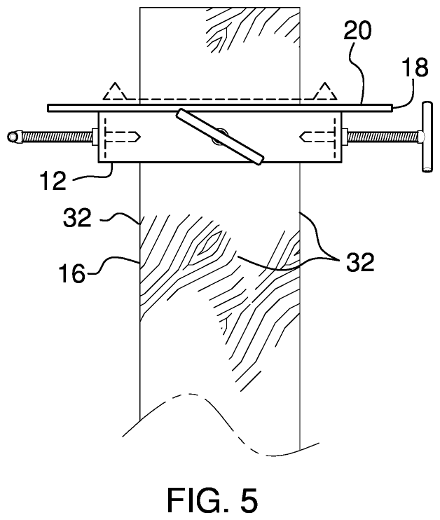

With reference now to the drawings, and in particular to FIGS. 1 through 5 thereof, a new jig device embodying the principles and concepts of an embodiment of the disclosure and generally designated by the reference numeral 10 will be described.

As best illustrated in FIGS. 1 through 5, the fence post jig assembly 10 generally comprises a frame 12 that has a plurality of intersecting sides 14 such that the frame 12 defines a rectangle. In this way the frame 12 can be positioned around a fence post 16. The fence post 16 may be a 4×4 post, a 6×6 post or any other rectilinear stanchion. The frame 12 has a lip 18 extending outwardly therefrom and the lip 18 extends around each of the intersecting sides 14 such that the lip 18 defines a guide surface 20. Moreover, the guide surface 20 is oriented on a horizontal plane when the frame 12 is positioned around the fence post 16. In this way the guide surface 20 can guide a saw to cut the fence post 16 along the horizontal plane thereby enhancing precision of cutting the fence post 16.

Each of the intersecting sides 14 has a top edge 22, a bottom edge 24 and an outer surface 26 extending between the top edge 22 and the bottom edge 24, and the outer surface 26 of each of the intersecting sides 14 has an outwardly facing side 28 and an inwardly facing side 30. The inwardly facing side 30 of the outer surface 26 of each of the intersecting sides 14 is directed toward respective sides 32 of the fence post 16 when the frame 12 is positioned around the fence post 16. The lip 18 extends outwardly from the outwardly facing side 28 of the outer surface 26 of each of the intersecting sides 14. The lip 18 has a top surface 33 and the top surface 33 is aligned with the top edge 22 of each of the intersecting sides 14. Moreover, the top surface 33 defines the horizontal plane when the frame 12 is positioned around the fence post 16.

Each of the intersecting sides 14 may have a height ranging between approximately 1.0 inch and 1.5 inches. Additionally, the lip 18 may extend away from the frame 12 a distance ranging between approximately 1.0 inches and 1.5 inches. The frame 12 and the lip 18 may be comprised of a plastic material in an entry level quality of construction. Additionally, the frame 12 and the lip 18 may be comprised of aluminum in a mid-level quality of construction. The frame 12 and the lip 18 may be comprised of steel in a deluxe level quality of construction.

A plurality of screws 34 is provided and each of the screws 34 extends through a respective one of the intersecting sides 14 of the frame 12. Each of the screws 34 extends toward a center of the frame 12 when the screws 34 are tightened. In this way each of screws 34 engages the fence post 16 for retaining the frame 12 on the fence post 16 at a desired height on the fence post 16. Each of the screws 34 has a first end 36 and a second end 38, and each of the screws 34 is centrally positioned on the respective intersecting side 14 with respect to four corners 26 of the frame 12. The first end 36 of each of the screws 34 tapers to a point such that the first end 36 of each of the screws 34 engages the fence post 16 with minimal damage when the screws 34 are tightened. Additionally, each of the screws 34 includes a handle 40 that is oriented transverse with the second end 38 such that the handle 40 on each of the screws 34 can be gripped for loosening or tightening the screws 34.

In use, the frame 12 is positioned around the fence post 16 and the frame 12 is positioned at a desired height on the fence post 16. Each of the screws 34 is tightened to retain the frame 12 at the desired height on the fence post 16. In this way the top surface 33 of the lip 18 serves as a guide for a saw to precisely cut the fence post 16 to the desired height. Thus, a cap or other type of ornament can be precisely fitted onto the fence post 16 when the fence post 16 is cut to the desired height.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fence post jig assembly for cutting a fence post along a level line, said assembly comprising:
a frame having a plurality of intersecting sides such that said frame defines a rectangle wherein said frame is configured to be positioned around a fence post, said frame having a lip extending outwardly therefrom, said lip extending around each of said intersecting sides such that said lip defines a guide surface being oriented on a horizontal plane when said frame is positioned around the fence post wherein said guide surface is configured to guide a saw to cut the fence post along the horizontal plane thereby enhancing precision of cutting the fence post; and
a plurality of screws, each of said screws extending through a respective one of said intersecting sides of said frame, each of said screws extending toward a center of said frame when said screws are tightened wherein each of screws is configured to engage the fence post for retaining said frame on the fence post at a desired height on the fence post.

2. The assembly according to claim 1, wherein each of said intersecting sides has a top edge, a bottom edge and an outer surface extending between said top edge and said bottom edge, said outer surface of each of said intersecting sides having an outwardly facing side and an inwardly facing side wherein said inwardly facing side of said outer surface of each of said intersecting sides is configured to be directed toward respective sides of the fence post when said frame is positioned around the fence post.

3. The assembly according to claim 2, wherein said lip extends outwardly from said outwardly facing side of said outer surface of each of said intersecting sides, said lip having a top surface, said top surface being aligned with said top edge of each of said intersecting sides, said top surface defining said horizontal plane when said frame is positioned around the fence post.

4. The assembly according to claim 1, wherein each of said screws has a first end and a second end, each of said screws being centrally positioned on said respective intersecting side with respect to four corners of said frame, said first end of each of said screws tapering to a point wherein said first end of each of said screws is configured to engage the fence post when said screws are tightened.

5. The assembly according to claim 4, wherein each of said screws includes a handle being oriented transverse with said second end wherein said handle on each of said screws is configured to be gripped for loosening or tightening said screws.

6. A fence post jig assembly for cutting a fence post along a level line, said assembly comprising:
a frame having a plurality of intersecting sides such that said frame defines a rectangle wherein said frame is configured to be positioned around a fence post, said frame having a lip extending outwardly therefrom, said lip extending around each of said intersecting sides such that said lip defines a guide surface being oriented on a horizontal plane when said frame is positioned around the fence post wherein said guide surface is configured to guide a saw to cut the fence post along the horizontal plane thereby enhancing precision of cutting the fence post, each of said intersecting sides having a top edge, a bottom edge and an outer surface extending between said top edge and said bottom edge, said outer surface of each of said intersecting sides having an outwardly facing side and an inwardly facing side wherein said inwardly facing side of said outer surface of each of said intersecting sides is configured to be directed toward respective sides of the fence post when said frame is positioned around the fence post, said lip extending outwardly from said outwardly facing side of said outer surface of each of said intersecting sides, said lip having a top surface, said top surface being aligned with said top edge of each of said intersecting sides, said top surface defining said horizontal plane when said frame is positioned around the fence post; and
a plurality of screws, each of said screws extending through a respective one of said intersecting sides of said frame, each of said screws extending toward a center of said frame when said screws are tightened wherein each of screws is configured to engage the fence post for retaining said frame on the fence post at a desired height on the fence post, each of said screws having a first end and a second end, each of said screws being centrally positioned on said respective intersecting side with respect to four corners of said frame, said first end of each of said screws tapering to a point wherein said first end of each of said screws is configured to engage the fence post with minimal damage when said screws are tightened, each of said screws including a handle being oriented transverse with said second end wherein said handle on each of said screws is configured to be gripped for loosening or tightening said screws.

7. A fence post jig system for cutting a fence post along a level line, said system comprising:
a fence post having a plurality of sides;
a frame having a plurality of intersecting sides such that said frame defines a rectangle thereby facilitating said frame to be positioned around said fence post, said frame having a lip extending outwardly therefrom, said lip extending around each of said intersecting sides such that said lip defines a guide surface being oriented on a horizontal plane when said frame is positioned around the fence post wherein said guide surface is configured to guide a saw to cut said fence post along the horizontal plane thereby enhancing precision of cutting said fence post, each of said intersecting sides having a top edge, a bottom edge and an outer surface extending between said top edge and said bottom edge, said outer surface of each of said intersecting sides having an outwardly facing side and an inwardly facing side, said inwardly facing side of said outer surface of each of said intersecting sides abutting respective sides of said fence post when said frame is positioned around said fence post, said lip extending outwardly from said outwardly facing side of said outer surface of each of said intersecting sides, said lip having a top surface, said top surface being aligned with said top edge of each of said intersecting sides, said top surface defining said horizontal plane when said frame is positioned around the fence post; and
a plurality of screws, each of said screws extending through a respective one of said intersecting sides of said frame, each of said screws extending toward a center of said frame when said screws are tightened to engage said fence post for retaining said frame on said fence post at a desired height on said fence post, each of said screws having a first end and a second end, each of said screws being centrally positioned on said respective intersecting side with respect to four corners of said frame, said first end of each of said screws tapering to a point, said first end of each of said screws to engaging said fence post with minimal damage when said screws are tightened, each of said screws including a handle being oriented transverse with said second end wherein said handle on each of said screws is configured to be gripped for loosening or tightening said screws.
